(19) United States
(12) Patent Application Publication
(10) Pub. No.: US 2016/0337636 A1
(43) Pub. Date: Nov. 17, 2016

(54) SYSTEM AND METHOD FOR EVENT RECONSTRUCTION

(71) Applicant: BARTCO TRAFFIC EQUIPMENT PTY LTD, Victoria (AU)

(72) Inventor: Troy Raymond Wollard, Port Melbourne (AU)

(21) Appl. No.: 15/111,650

(22) PCT Filed: Jan. 16, 2015
(86) PCT No.: PCT/AU2015/050015

§ 371 Date: Jul. 14, 2016

(30) Foreign Application Priority Data
Jan. 16, 2014 (AU) 2014900136

(51) Int. Cl. H04N 13/02; H04N 13/00; H04N 5/76; H04N 5/247

(52) U.S. Cl. CPC H04N 13/0282; H04N 5/247; H04N 13/0014; H04N 13/0203; H04N 5/76; H04N 2013/0074; G06T 2200/04; G06T 2207/10021; G06T 2207/10028; G06T 2207/30236; G06T 2207/30201; G06T 2210/21; H04N 2213/001

(57) ABSTRACT

A system for event reconstruction including: a plurality of cameras installed at a location in expectation of an event, each of the cameras being arranged to simultaneously capture video of an area of interest from a unique viewpoint to capture footage of the event occurring at said area of interest; and a processing device; wherein the processing device processes the video captured by the cameras to produce a three-dimensional reconstruction of the event.

### FIELD OF THE INVENTION

The invention relates to a system and method for event reconstruction and, more particularly, but not exclusively, to a system and method for reconstruction of a motor vehicle accident at a traffic intersection, a criminal act, or some other event of interest.

### BACKGROUND OF THE INVENTION

Motor vehicle accidents can be relatively common at busy traffic intersections. It can be difficult or impossible to determine the cause of a motor vehicle accident, the progression of an accident, and the party at fault. It would be of interest to insurance companies in particular to accurately reconstruct traffic accident events It has previously been proposed to attempt to reconstruct traffic accidents by viewing damage of vehicles and by studying vehicle skid marks, however such techniques are prone to error and sufficient evidence may not be available to reconstruct a traffic accident using, only the evidence available after an accident has occurred. Furthermore, the applicant has identified that (i) witnesses may not be reliable; (ii) typical fixed cameras (for example, closed-circuit television (CCTV) or red light traffic cameras) can only provide a single point of view, which viewpoint may not be optimal; and (iii) there is often a high cost for employing investigative resources.

The applicant has identified that existing methods of reconstructing traffic accidents are inaccurate and can lead to expensive and time consuming argument.

Examples of the invention seek to provide an improved system for event reconstruction of a traffic accident, or a criminal act. which overcomes or at least alleviates disadvantages associated with existing reconstruction techniques.

### SUMMARY OF THE INVENTION

In accordance with the present invention, there is provided a system for event reconstruction including: a plurality of cameras installed at a location in expectation of an event, each of the cameras being arranged to simultaneously capture video of an area of interest from a unique viewpoint to capture footage of the event occurring at said area of interest; and a processing device; wherein the processing device processes the video captured by the cameras to produce a three-dimensional reconstruction of the event.

Preferably, the cameras are video cameras. The cameras may include infrared thermal imaging time of flight (TOF) depth, night vision and/or other features. TOF cameras are a form of range-imaging camera which is able to resolve distance based on the speed of light and is able to operate quickly offering many images per second. The applicant has identified that TOF cameras may be of particular utility in a system for event reconstruction as they may assist in, determining distances of objects in the footage and therefore in generating three-dimensional reconstructions.

Preferably, the processing device stores the three-dimensional reconstruction on a tangible computer readable medium. More preferably, the tangible computer readable medium is local to said system. The video captured by the cameras may be transferred to storage so that the event/scene can be reconstructed at a later date.

In a preferred form, the processing device allows a user to select an observation point in space different to the viewpoints of the cameras and to view the event from said observation point.

Preferably, the location is a roadway intersection, and the event is a vehicle accident.

Alternatively, the event is a criminal event. In one form, the location is a bank and the criminal event is a robbery of the bank.

Preferably, the processing device allows a user to calculate a velocity of an object in the area of interest at a given time.

Preferably, the processing device allows a user to view the event from a perspective of a driver of a vehicle involved in the event. More preferably, the processing device allows a user to determine a position and orientation of the driver's head.

In one form, the processing device provides facial recognition of individuals involved in the event.

Preferably, the processing device transfers the reconstruction of the event wirelessly to a different location. Alternatively, the video captured by the cameras may be transmitted wirelessly. by wire, fibre optic, or any other transmission method/means. Similarly, the reconstruction of the even may be transmitted by any of these methods/means.

In a preferred form, the system uses identification of heat and/or sound associated with an event to initiate capture of video of the area of interest. Alternatively, the system may use a speed radar or other means for initiating capture of video.

Storage of the video captured by the cameras may be looped.

Preferably, the processing device combines sound recordal at each of the cameras to contribute to determination of location, direction of movement and/or speed of objects in the area of interest. Sound may be reconstructed by the system to match a playback viewpoint.

In accordance with another aspect of the invention, there is provided a method of reconstructing an event including the steps of installing a plurality of cameras at a location in expectation of an event; operating each of the cameras to simultaneously capture video of an area of interest, each from a unique viewpoint, to capture footage of the event occurring at said area of interest; and processing video captured by the cameras to produce a three-dimensional reconstruction of the event.

### BRIEF DESCRIPTION OF THE DRAWINGS

The invention is described, by way of non-limiting example only with reference to the accompanying drawings, in which:

FIG. 1 is a diagrammatic sketch of a system for reconstructing a traffic accident event in accordance with an example of the present invention.

### DETAILED DESCRIPTION

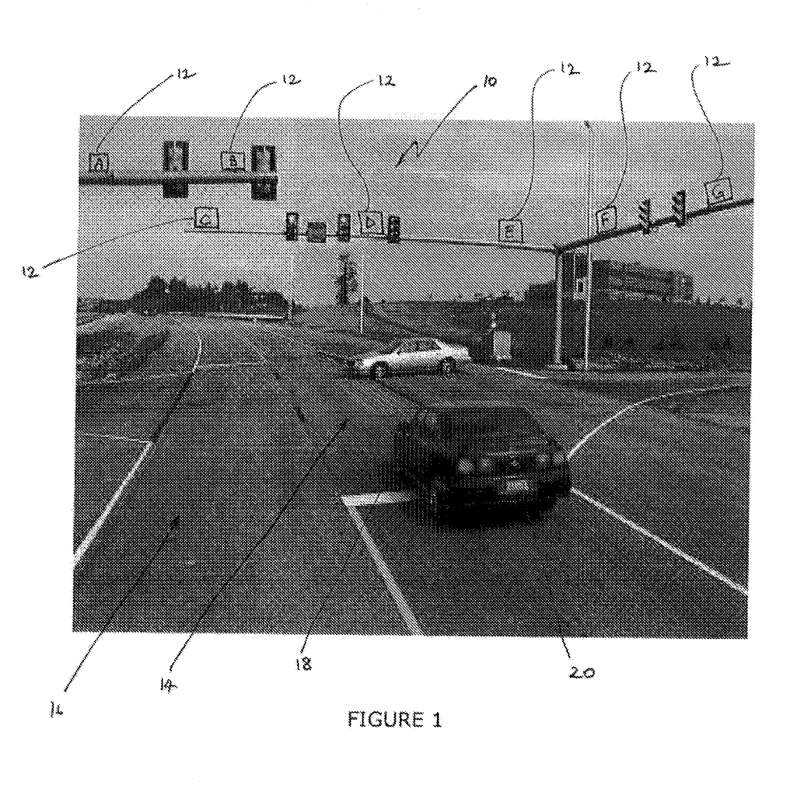

With reference to FIG. 1, there is shown a system 10 for event reconstruction.

Advantageously, the system 10 allows accurate production of a three-dimensional reconstruction of a traffic accident by virtue of a plurality of video cameras taking video footage of a traffic intersection from different angles.

More specifically, there is provided a system 10 for event reconstruction including:

a plurality of cameras 12 installed at a location in expectation of an event, each of the cameras 12 being arranged to simultaneously capture video of an area of interest 14 from a unique viewpoint. In this way, footage of the event occurring at the area of interest 14 is captured. The system 10 also includes a processing device which processes the video captured by the cameras 12 to produce a three-dimensional reconstruction of the event.

The cameras 12 may be video cameras, however in alternative examples still cameras may be used, particularly where still cameras are able to take regular still photographs at time intervals. The processing device may store the three-dimensional reconstruction on a tangible computer readable medium. The tangible computer readable medium may he local to the system 10. In particular, the tangible computer readable medium may he in the form of data storage which is mounted in the same unit as one or more of the cameras 12.

One or more of the cameras may be time-of-flight (TOF) cameras. A TOF camera is a form of range-imaging camera which is able to resolve distance based on the speed of light and is able to operate quickly, offering mans images per second. The applicant has identified that TOF cameras may be of particular utility in a system for event reconstruction in accordance with the invention as they may assist in determining distances of objects in the footage and therefore in generating three-dimensional reconstructions. Advantageously, TOF cameras are able to measure distances within a complete scene with a single shot. As TOF cameras can reach 160 frames per second, the applicant has recognised that they are ideally suited for use in a system for reconstructing an event in accordance with the present invention which may require detailed analysis of fast-moving objects.

One of more cameras of the system may include infrared thermal imaging, night vision and/or other features.

Advantageously, the processing device may allow a user to select an observation point in space different to the viewpoints of the cameras 12 and to view the event from the observation point. For example, the cameras 12 may be mounted to traffic light poles as shown in FIG. 1, and an observation point corresponding to the view point of a driver of a vehicle involved in an accident may be selected by a user for viewing the reconstruction of the traffic accident to determine what was seen by the driver before and during the accident.

The location may be in the form of a roadway intersection 16 as shown in FIG. 1. In that case, the event may be in the form of a vehicle accident. Alternatively, in other examples, the event may take a different form. For example, the event may be in the form of a criminal event. Specifically, the location may be in the form of a bank (or other business or residential place) and the criminal event may be in the form of a robbery of the bank. In such an example, the system 10 may be used to re-enact the robbery to identify those responsible and the actions taken by individuals during the robbery. In other examples, the system 10 may be used to reconstruct other events, including other types of crimes, or even sports, stunts or music performances. The reconstruction may allow the user to choose any vantage point within an entire volume of the location of interest so that different features may be examined in detail after the event.

The actual processing of the footage may be conducted by way of known 3D data reconstruction methods.

Advantageously, the processing device may allow a user to calculate a velocity of an object in the area of interest 14 at a given time. More specifically, where the system 10 is used to reconstruct a traffic accident event, the processing device may allow a user to calculate a velocity of a vehicle 20 in the roadway intersection 16, for example to be used by police to determine whether the vehicle was speeding in excess of speed limits.

The processing device may also allow a user to view the event from a perspective of a driver 18 of a vehicle 20 involved in the traffic accident. In particular, the processing device may facilitate determination of a position and orientation of the head of the driver 18 to ascertain where the driver's attention was in advance of the accident. The processing device may also provide facial recognition of individuals involved in the event, and facial detail may be examined by manipulating the observation point accordingly during viewing of the event reconstruction.

The processing device may be used to transfer the reconstruction of the event wirelessly to a different location. In this way, the reconstruction may be transmitted by way of a cellular network to a remote location for storage and analysis. Alternatively, video footage captured by the cameras 12 may be stored locally to the system 10 and may be looped to make efficient usage of storage space. The system 10 may use identification of heat and/or sound (for example, recognising the heat or sound of a vehicle accident pre-programmed into the system 10) associated with an event of interest to initiate capture of video by the cameras 12, and storage of data may cease in the absence of such identification to conserve power and storage. Initiation of storage of video may also be triggered by preset visual activity observed by the cameras 12.

In one form, the processing device may combine sound recordal at each of the cameras 12 to contribute to determination of location, direction of movement arid/or speed of objects in the area of interest. For example, the sound recorded by each camera 12 may be combined and analysed (or “stitched”) to enhance measurements taken from visual photographic footage.

In examples of the invention, the system may include automatic vehicle type recognition, lane car counting and/or passenger counting. More specifically, the system for event reconstruction may be arranged to automatically recognise vehicle types/models from the video footage and/or from the three-dimensional reconstruction, for example by shape matching or by assessment of dimensions. Similarly, the system for event reconstruction may be arranged to count vehicles and/or count passengers from the video footage and/or from the three-dimensional reconstruction. In a further variation, the system for event reconstruction may be arranged to recognise specific vehicles and/or recognise passengers from the video footage and/or from the three-dimensional reconstruction.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that poor publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will he understood to imply the inclusion of a stated integer or step or group of integers or steps but not the exclusion of any other integer or step or group of integers or steps.

1. A system for event reconstruction including:
a plurality of cameras installed at a location in expectation of an event, each of the cameras being arranged to simultaneously capture photography of an area of interest from a unique viewpoint to capture footage of the event occurring at said area of interest; and
a processing device;
wherein the processing device processes the photography captured by the cameras to produce a three-dimensional reconstruction of the event.

2. A system as claimed in claim 1, wherein the cameras are video cameras and the photography is video photography.

3. A system as claimed in claim 1, wherein the cameras are time-of-flight (TOF) cameras.

4. A system as claimed in claim 1, wherein the processing device stores the three-dimensional reconstruction on a tangible computer readable medium.

5. A system as claimed in claim 2, wherein the processing device allows a user to select an observation point in space different to the viewpoints of the cameras and to view the event from said observation point.

6. A system as claimed in claim 1, wherein the location is a roadway intersection, and the event is a vehicle accident.

7. A system as claimed in claim 1, wherein the event is a criminal event.

8. A system as claimed in claim 7, wherein the location is a bank and the criminal event is a robbery of the bank.

9. A system as claimed in any one claim 6, wherein the processing device allows a user to calculate a velocity of an object in the area of interest at a given time.

10. A system as claimed in any one claim 6, wherein the processing device allows a user to view the event from a perspective of a driver of a vehicle involved in the event.

11. A system as claimed in any one claim 10, wherein the processing device allows a user to determine a position and orientation of the driver's head.

12. A system as claimed in claim 1, wherein the processing device provides face recognition of individuals involved in the event.

13. A system as claimed in claim 4, wherein the tangible computer readable medium is local to said system.

14. A system as claimed in claim 1, wherein the processing device transfers the reconstruction of the event wirelessly to a different location.

15. A system as claimed in claim 1, wherein the system uses identification of heat and/or sound associated with an event to initiate capture of photography of the area of interest.

16. A system as claimed in claim 1, wherein storage of the photography captured by the cameras is looped.

17. A system as claimed in claim 1, wherein the processing device combines sound recordal at each of the cameras to contribute to determination of location, direction of movement and/or speed of objects in the area of interest.

18. A method of reconstructing an event including the steps of:
installing a plurality of cameras at a location in expectation of an event;
operating each of the cameras to simultaneously capture photography of an area of interest, each from a unique viewpoint, to capture footage of the event occurring at said area of interest; and
processing photography captured by the cameras to produce a three-dimensional reconstruction of the event.

19-20. (canceled)
